(19) United States
(12) Patent Application Publication
(10) Pub. No.: US 2024/0147217 A1
(43) Pub. Date: May 2, 2024

(54) Method and Device for Dynamically Personalizing a Wireless Communication Device

(71) Applicant: QUALCOMM Incorporated, San Diego, CA (US)

(72) Inventors: Venkata Durga Vinod CHIKKALA, Hyderabad (IN); Rajendra Prasad NELUROUTH, Hyderabad (IN); Bhanu Prakash CHOUHAN, Erie, CO (US); Tauseef Ahmad QIDWAI, Hyderabad (IN)

(21) Appl. No.: 18/548,081

(22) PCT Filed: May 5, 2022
(86) PCT No.: PCT/US2022/027931

§ 371 Date: Aug. 26, 2023

(30) Foreign Application Priority Data
Jun. 4, 2021 (IN) 202141024944

(51) Int. Cl. H04W 8/18; H04W 12/72; H04W 48/18

(52) U.S. Cl. CPC H04W 8/183; H04W 12/72; H04W 48/18

(57) ABSTRACT

Various embodiments include methods and devices for dynamically personalizing a wireless communication device. Embodiment methods may include analyzing a USIM AID (Application ID) list contained in the elementary file directory (EF-DIR) of an inserted SIM card for codes for personalization categories indicative of IMSI based, non-IMSI based, or both. Based on the 3G App code in USIM AID found in the EF-DIR, the corresponding personalization categories and values may be retrieved from ME database. The data required for personalization and their values contained in the inserted SIM card may be compared against the personalization category and values retrieved from the database. Access to camp on a mobile network may be dependent on the comparison of personalization category values and codes.

### RELATED APPLICATION

This application is the U.S. national stage application for and claims priority to PCT Application No. PCT/US2022/027931 entitled “Method and Device for Dynamically Personalizing a Wireless Communication Device” that was filed May 5, 2022, which claims the benefit of priority from Indian Provisional Application No. 202141024944, filed Jun. 4, 2021; the entire contents of which is herein incorporated by reference.

### BACKGROUND

Mobile network operators sell wireless communication devices, such as smartphones, personalized to their mobile networks at subsidized prices. The subsidy is given to attract users to use an operator's mobile network and charge the users for cellular and value-added services. Thus, for mobile network operators, wireless communication device personalization security is important to ensure the subsidized wireless communication devices generate revenue at the subsidized price. Personalization of a wireless communication device to a mobile network binds or locks the wireless communication device to the operator's mobile network. For example, only subscriber identification module (SIM) cards issued by the mobile network operator can be used on personalized wireless communication device. In this manner, the subsidized personalized wireless communication device may be bound or locked for use to the operator's mobile network.

Authentication between a user's wireless communication device and the mobile network operator that the user's wireless communication device is operating on may be based on a shared symmetric key. Such authentication may occur after identification of the user's wireless communication device. Previously released wireless communication protocols (e.g., 4G and prior protocols) support the use of international mobile subscriber identifiers (IMSI) to uniquely identify and authorize a SIM card that is in use with a wireless communication device. With the advent of the 5G wireless communication protocol, new Subscription Permanent Identifiers (SUPI) may be used to uniquely identify and authorize a SIM card that is in use with a wireless communication device. However, a user may desire to operate the wireless communication device on a plurality of mobile networks that include both 5G networks and prior legacy networks. Thus, the SUPI may be include both IMSI-based SUPI and non-IMSI based SUPI.

### SUMMARY OF THE INVENTION

Various aspects include apparatuses and methods for dynamically personalizing a wireless communication device. Various aspects may include retrieving universal Subscriber Identity Module (USIM) application identifier (AID) 3G App codes contained in an elementary file directory (EF-DIR) list stored on a subscriber identification module (SIM) card that is inserted in the wireless communication device, in response to the retrieved USIM AID 3G code indicating an application of international mobile subscriber identification (IMSI) based Subscription Permanent Identifier (SUPI) personalization categories: retrieving IMSI based SUPI personalization category data from a IMSI based personalization category mobile equipment (ME) database; and allowing the wireless communication device to camp to an IMSI based network in response to the retrieved IMSI based SUPI personalization category data matching personalization category data stored on the SIM card, and in response to the retrieved USIM AID 3G code indicating an application of non-IMSI based SUPI personalization categories: retrieving non-IMSI based SUPI personalization category data from a non-IMSI based personalization category ME database; and allowing the wireless communication device to camp to a non-IMSI based network in response to the retrieved non-IMSI based SUPI personalization category data matching personalization category data stored on the SIM card.

In some aspects, a retrieved USIM AID 3G App code that is a hexadecimal code other than 100B indicates an application of IMSI based SUPI personalization categories. In some aspects, a retrieved USIM AID 3G code that is a hexadecimal code 100B indicates an application of non-IMSI based SUPI personalization categories.

In some aspects, a single IMSI and non-IMSI based personalization category ME database may include the IMSI based personalization category ME database and the non-IMSI based personalization category ME database. In some aspects, each of the IMSI based personalization category ME database and non-IMSI based personalization category ME database may be configured by an original equipment manufacturer (OEM) or mobile network operator.

In some aspects, the IMSI based SUPI personalization categories may include a mobile country code (MCC), a mobile network code (MNC), a group identifier level 1 (GID1), or a group identifier level 2 (GID2). In some aspects, the non-IMSI based SUPI personalization categories may include an elementary file SUPI network access identifier (EF_{SUPI_NAI}), Network Subscription Identifier (NSI), a global cable identifier (GCI), or a global line identifier (GLI).

Some aspects may further include not allowing the wireless communication device to camp to an IMSI based network in response to the retrieved IMSI based SUPI personalization category data not matching personalization category data stored on the SIM card, and not allowing the wireless communication device to camp to a non-IMSI based network in response to the retrieved non-IMSI based SUPI personalization category data not matching personalization category data stored on the SIM card.

Some aspects may further include a wireless communication device having a processor configured to perform operations of any of the methods summarized above. Some aspects may further include a wireless communication device having means for performing functions of any of the methods summarized above. Some embodiments may include non-transitory, processor-readable media on which are stored processor-executable instructions configured to cause a processor of a wireless communication device to perform operations of any of the methods summarized above.

### BRIEF DESCRIPTION OF THE DRAWINGS

The accompanying drawings, which are incorporated herein and constitute part of this specification, illustrate example aspects of various embodiments, and together with the general description given above and the detailed description given below, serve to explain the features of the claims.

FIG. 1 is a component block diagram illustrating an example wireless communication device suitable for implementing various embodiments.

FIG. 2 is a component block diagram illustrating an interaction between components of a wireless communication device.

FIG. 3 is a component block diagram illustrating an example wireless communication device suitable for implementing various embodiments.

FIG. 4 is a component block diagram illustrating an example multicore processor suitable for implementing various embodiments.

FIGS. 5A-5D are process flow diagrams illustrating a method for dynamically personalizing a wireless communication device according to an embodiment.

FIG. 6 is a component block diagram illustrating an example wireless communication device suitable for use with the various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

The term “wireless communication device” is used herein to refer to any of a variety of communication devices that receive communication services via mobile communication networks (“mobile networks”), including for example smartphones, mobile computing devices, cellular-based wireless hotspots, and the like. Wireless communication devices are also commonly referred to as user equipment (UE), mobile devices, and cellular devices.

In today's telecommunication systems, mobile network operators may allocate a unique identifier to each SIM card. In legacy 4G mobile networks and earlier protocol mobile networks (e.g., 3G/2G etc.), the unique identifier may be referred to as an International Mobile Subscriber Identity (IMSI). In more recently deployed 5G mobile networks, the unique identifier may be referred to as a Subscription Permanent Identifier (SUPI). In order to authenticate a user's wireless communication device to a mobile network operator whose network the wireless communication device seeks to attach itself, the wireless communication device must be identified. Once identified, the wireless communication device may be authenticated to the mobile network operator based on a shared symmetric key. However, if the IMSI/SUPI values are sent in plaintext over the radio access link, then users can be identified, located and tracked using these permanent identifiers.

A SUPI is a 5G globally unique Subscription Permanent Identifier (SUPI) allocated to each subscriber and defined in 3GPP specification technical specification (TS) 23.501. The SUPI value is provisioned in USIM and Unified Data Management (UDM)/Unified Data Repository (UDR) function in 5G Core. A Valid SUPI can be either of following: An IMSI (International Mobile Subscriber Identifier) as defined in TS 23.503 for 3GPP radio access technology (RAT); or a NAI (Network Access Identifier) as defined in RFC 4282 based user identification as defined in TS 23.003 for non-3GPP RAT. A SUPI is usually a string of 15 decimal digits. The first three digits represent the Mobile Country Code (MCC) while the next two or three form the Mobile Network Code (MNC) identifying the mobile network operator. The remaining (nine or ten) digits are known as Mobile Subscriber Identification Number (MSIN) and represent the individual user of that particular operator. SUPI as used on 5G networks is equivalent to IMSI as used in prior 4G and other legacy networks, which uniquely identifies the wireless communication device, is also a string of 15 digits.

In today's market, many mobile network operators that all over the world who sell personalized devices to the users at subsidy prices. For mobile network operators, personalization security may be sought after to ensure they generate the revenue for the devices sold at subsidy price. Mobile network operators that operate earlier legacy networks (2G/3G/4G, etc.) may personalize a wireless communication device by providing the SIM with specific data values for IMSI-based SUPI personalization categories (i.e., categories whose data value may limit or “lock” operation to mobile networks using the same data values for the personalization categories). These IMSI-based personalization categories may include Mobile Country Code (MCC)/Mobile Network Code (MNC), a group identifier level 1 (GID1), a group identifier level 2 (GID2) and other IMSI-based categories (3GPP TS 22.022).

With the introduction of non-IMSI based SUPI in SGNR (Rel 16), a new identifier is introduced in 3GPP TS 31.102, namely the Elementary File SUPI_Network Access Identifier (EFSUPI_NAI (4F09)). In accordance with the specification for 3GPP TS 31.102 (REL16), EFSUPI_NAI contains SUPI with a value for no active carrier subscription (NSI), a global cable identifier (GCI), or a global line identifier (GLI). Moreover, emerging standards for 5G network operation may provide for additional personalization categories in the future. Thus, a secure personalization solution may be sought that enables both IMSI & non-IMSI based SUPI personalization categories in the device (single SKU) and yet choose only the required set of categories for device personalization

Various embodiments include methods, and wireless communication devices implementing such methods, for dynamically personalizing a wireless communication device for operation on both IMSI-based and non-IMSI-based networks. In particular, various embodiments disclosed herein may personalize (i.e., lock) a wireless communication device using non-IMSI based SUPI (NSI/GLI/GCI (EFSUPI_NAI)) personalization categories. In addition, various embodiment may allow the mobile network operator to enable both IMSI-based SUPI personalization categories and non-IMSI based SUPI personalization categories based on the type of SIM card (e.g., Embedded Universal Integrated Circuit Card (eUICC)/Universal Integrated Circuit Card (UICC)/ Integrated Circuit Card (ICC)) that may be inserted into the wireless communication device. Thus, various embodiments provide a secure personalization solution to enable both IMSI & non-IMSI based SUPI personalization categories in the wireless communication device and yet choose only the required set of categories for wireless communication device personalization.

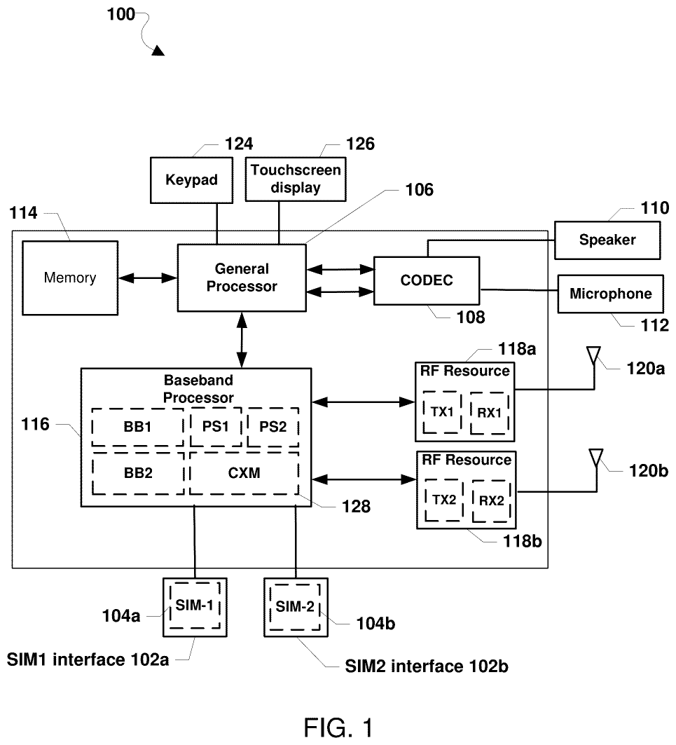

FIG. 1 illustrates components of a wireless communication device 100 that is suitable for implementing the various embodiments. The various embodiments described herein may be implemented in a wireless communication device 100 that operates within a variety of communication systems, such as any number of mobile networks, such as mobile telephony networks. In various embodiments, a wireless communication device 100 may support any number of subscriptions to mobile telephony networks. To support subscriptions to multiple mobile telephony networks, in some embodiments the wireless communication device 100 may be a multi-SIM communication device. The wireless communication device 100 may communicate with a mobile telephony network via a cellular connection to a base station of the mobile telephony network. The cellular connection may be made through two-way wireless communication links using a variety of communication technologies, such as Long Term Evolution (LTE), fifth generation (5G), fourth generation (4G), third generation (3G), Code Division Multiple Access (CDMA), Time Division Synchronous Code Division Multiple Access (TD-SCDMA), Wideband Code Division Multiple Access (WCDMA), Global System for Mobile communication (GSM), and other mobile telephony communication technologies. Other connections may include various other wireless connections, including WLANs, such as Wi-Fi based on Institute of Electrical and Electronics Engineers (IEEE) 802.11 standards, and wireless location services, such as the Global Positioning System (GPS).

With reference to FIG. 1, the wireless communication device 100 may include any number of subscriber identity modules (SIM) interfaces which may receive an identity module. The wireless communication device 100 may include a first subscriber identity module (SIM) interface 102a, which may receive a first identity module SIM-1 104a that is associated with a first subscription to a first mobile telephony network. In various embodiments, the wireless communication device 100 may be a multi-subscription wireless communication device including a second (or more) SIM interface 102b, which may receive a second identity module SIM-2 104b that is associated with a second subscription to a second mobile telephony network.

A SIM card is designed to fit into a wireless communication device. The SIM card provides the identification of a wireless communication device to a mobile network, allowing the wireless communication device access to such communications services such as telephony, email, Internet, text messaging, data, etc. A SIM 104a, 104b in the various embodiments may be a Universal Integrated Circuit Card (UICC) that is configured with SIM and/or Universal SIM (USIM) applications, enabling access to, for example, GSM, and/or Universal Mobile Telecommunications System (UMTS) networks. The UICC may also provide storage for a phone book and other applications. Alternatively, in a CDMA network, a SIM may be a UICC removable user identity module (R-UIM) or a CDMA subscriber identity module (CSIM) on a card.

Each SIM 104a, 104b may have a central processor unit (CPU), read only memory (ROM), random access memory (RAM), electrically erasable programmable read only memory (EEPROM), and input/output (I/O) circuits. A SIM used in the various embodiments may contain user account information, an international mobile subscriber identity (IMSI), a set of SIM method application toolkit (SAT) commands, and storage space for phone book contacts. A SIM may further store a mobile country code (MCC), mobile network code (MNC), and a Home Public-Land-Mobile-Network (HPLMN) code to indicate the SIM card network operator provider. An Integrated Circuit Card Identity (ICCID) SIM serial number may be printed on the SIM for identification.

The SIM card 104a, 104b memory structure may be composed of directories that may be roughly analogous to directories of a traditional computer hard drive. The file system of these directories may include the following basic forms: a master file (MF), a directory file (DF) and an elementary file (EF). Each of these files may in turn include a director of the files contained therein. For example, the EF may contain data values for a variety for assigned categories. As an example of an assigned category may be the USIM application identifier (AID) 3 G code. The USIM AID 3G code may be a four digit hexadecimal value. To identify non-IMSI based categories (i.e., categories identified in the 5G protocol), the USIM AID 3G code may be assigned the four digit hexadecimal code of “100B”. To identify IMSI-based categories (i.e., pre-5G legacy protocols), the USIM AID 3G code may be assigned the four digit hexadecimal code of value other than “100B” (i.e., “not 100B”).

Each wireless communication device 100 may include at least one controller, such as a general purpose processor 106 (e.g., a CPU), which may be coupled to a coder/decoder (CODEC) 108. The CODEC 108 may be coupled to a speaker 110 and a microphone 112. The general purpose processor 106 may also be coupled to at least one memory 114. The memory 114 may be a non-transitory tangible computer readable storage medium that stores processor-executable instructions. For example, the instructions may include routing communication data relating to a subscription though a corresponding baseband-radio frequency (RF) resource chain, or RF chain.

The memory 114 may store operating system (OS) software, as well as user application software and executable instructions. The memory 114 may also store application data, such as an array data structure.

The general purpose processor 106 and memory 114 may each be coupled to at least one baseband modem processor 116. In various embodiments each SIM 104a, 104b in the wireless communication device 100 may be associated with a baseband-RF resource chain. In various embodiments, multiple SIMs 104a, 104b may be associated with a common baseband-RF resource chain shared by two or more SIMs 104a, 104b, or a SIM 104a, 104b may be associated with a dedicated baseband-RF resource chain. Each baseband-RF resource chain may include the baseband modem processor 116 to perform baseband/modem functions for communications on a SIM 104a, 104b, and one or more amplifiers and radios, referred to generally herein as RF resources 118a, 118b. In some embodiments, baseband-RF resource chains may interact with a shared baseband modem processor 116 (i.e., a single device that performs baseband/modem functions for all SIMs 104a, 104b on the wireless communication device). Alternatively, each baseband-RF resource chain may include physically or logically separate baseband processors (e.g., BB1, BB2).

In some embodiments, the baseband modem processor 116 may be an integrated chip capable of managing the protocol stacks of each of the SIMs 104a, 104b or subscriptions (e.g., PS1, PS1) and implementing a co-existence manager software 128 (CXM). By implementing modem software, subscription protocol stacks, and the co-existence manager software on this integrated baseband modem processor 116, thread based instructions may be used on the integrated baseband modem processor 116 to communicate instructions between the software implementing interference mitigation techniques for co-existence issues, and the receive (Rx) and transmit (Tx) operations.

The RF resources 118a, 118b may be communication circuits or transceivers that perform transmit/receive functions for the associated SIM 104a, 104b of the wireless communication device 100. The RF resources 118a, 118b may be communication circuits that include separate transmit and receive circuitry, or may include a transceiver that combines transmitter and receiver functions. The RF resources 118a, 118b may be coupled to a wireless antenna (e.g., a first wireless antenna 120a and a second wireless antenna 120b). The RF resources 118a, 118b may also be coupled to the baseband modem processor 116.

In some embodiments, the general purpose processor 106, memory 114, baseband processor(s) 116, and RF resources 118a, 118b may be included in the wireless communication device 100 as a system-on-chip (SoC). In other embodiments, the first and second SIMs 104a, 104b and their corresponding interfaces 102a, 102b may be external to the system-on-chip. Further, various input and output devices may be coupled to components on the system-on-chip, such as interfaces or controllers. Example user input components suitable for use in the wireless communication device 100 may include, but are not limited to, a keypad 124 and a touchscreen display 126.

In some embodiments, the keypad 124, touchscreen display 126, microphone 112, or a combination thereof, may perform input functions to the wireless communication device 100 and any processes and applications implemented on the wireless communication device 100, such as the function of receiving the request to initiate an outgoing call. For example, the touchscreen display 126 may receive a selection of a contact from a contact list or receive a telephone number. In another example, either or both of the touchscreen display 126 and microphone 112 may perform the function of receiving a request to initiate an outgoing call. For example, the touchscreen display 126 may receive selection of a contact from a contact list or receive the input of a telephone number. As another example, the request to initiate the outgoing call may be in the form of a voice command received via the microphone 112. Interfaces may be provided between the various software modules and functions in the wireless communication device 100 to enable communication between them, as is known in the art.

In some embodiments, the wireless communication device 100 may be a single-technology or multiple-technology device having more or less than two RF chains. Further, various embodiments may be implemented in single RF chain or multiple RF chain wireless communication devices with fewer SIM cards than the number of RF chains, including devices that do not use any physical SIM cards relying instead on virtual SIM applications. In various embodiments, the wireless communication device 100 having a common baseband-RF resource chain may be capable of operating in a single radio LTE mode to allow multiple radio access technologies to share the common baseband-RF resource chain.

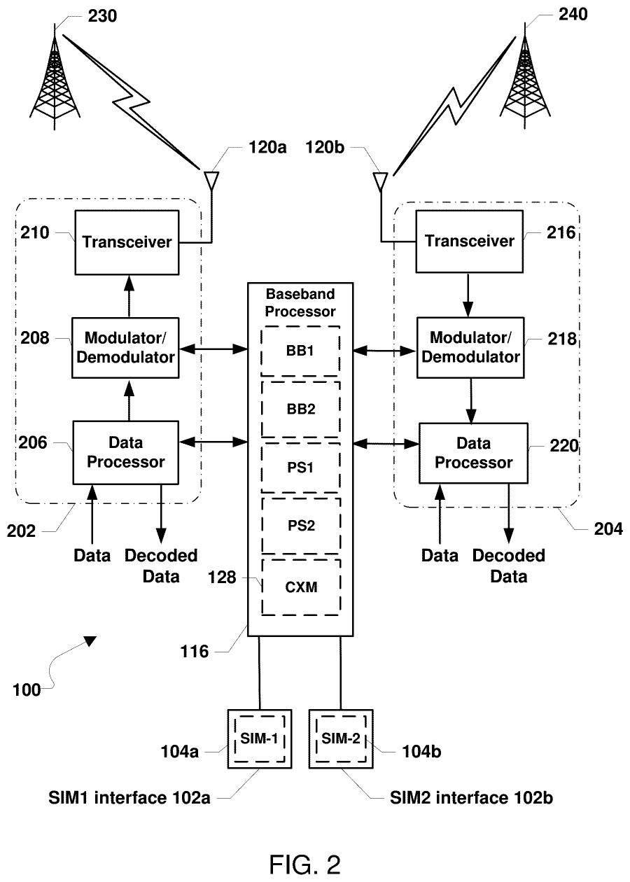

FIG. 2 illustrates interactions between components of RF chains, or transmit/receive chains in a wireless communication device 100 according to some embodiments. With reference to FIGS. 1 and 2, the wireless communication device 100 may be configured to communicate with any number of base stations 230, 240 using any number of radio access technologies (RATs). In some embodiments, the RAT may be a 5G private network. Thus, the base station 230, 240 may include a gateway device that allows the wireless communication device 100 to attach to the 5G private network. The wireless communication device 100 may include a first radio technology RF chain 202 including one RF resource 118a, and a second radio technology RF chain 204 including another RF resource 118b. The first and second radio technology RF chains 202, 204 may include components operable for transmitting data. The wireless communication device 100 may include a data processor 206, 220 configured to format, encode, and interleave data to be transmitted. The wireless communication device 100 may include a modulator/demodulator 208, 218 configured to modulate a carrier signal with encoded data, for example, by performing Gaussian minimum shift keying (GMSK). The wireless communication device 100 may include one or more transceiver circuits 210, 216 configured to condition the modulated signal (e.g., by filtering, amplifying, and up-converting) to generate a RF modulated signal for transmission. The RF modulated signal may be transmitted to a base station 230, 240 via an antenna 120a, 120b.

The components of the first and second radio technology RF chains 202, 204 may also be operable to receive data. When receiving data, the antenna 120a, 120b may receive modulated RF signals from a base station 230, 240. The one or more transceiver circuits 210, 216 may condition (e.g., filter, amplify, and down-convert) the received RF modulated signal, digitize the conditioned signal, and provide samples to the modulator/demodulator 208, 218. The modulator/demodulator 208, 218 may extract the original information-bearing signal from the modulated carrier wave, and may provide the demodulated signal to the data processor 206, 220. The data processor 206, 220 may de-interleave and decode the signal to obtain the original, decoded data, and may provide decoded data to other components in the wireless communication device.

Operations of the first and second radio technology RF chains 202, 204 may be controlled by a processor, such as a baseband processor(s) 116. Each of the first and second radio technology RF chains 202, 204 may be implemented as circuitry that may be separated into respective receive and transmit circuits (not shown). Alternatively, the first and second radio technology RF chains 202, 204 may combine receive and transmit circuitry (e.g., as transceivers associated with SIM-1 104a and SIM-2 104b in FIG. 1).

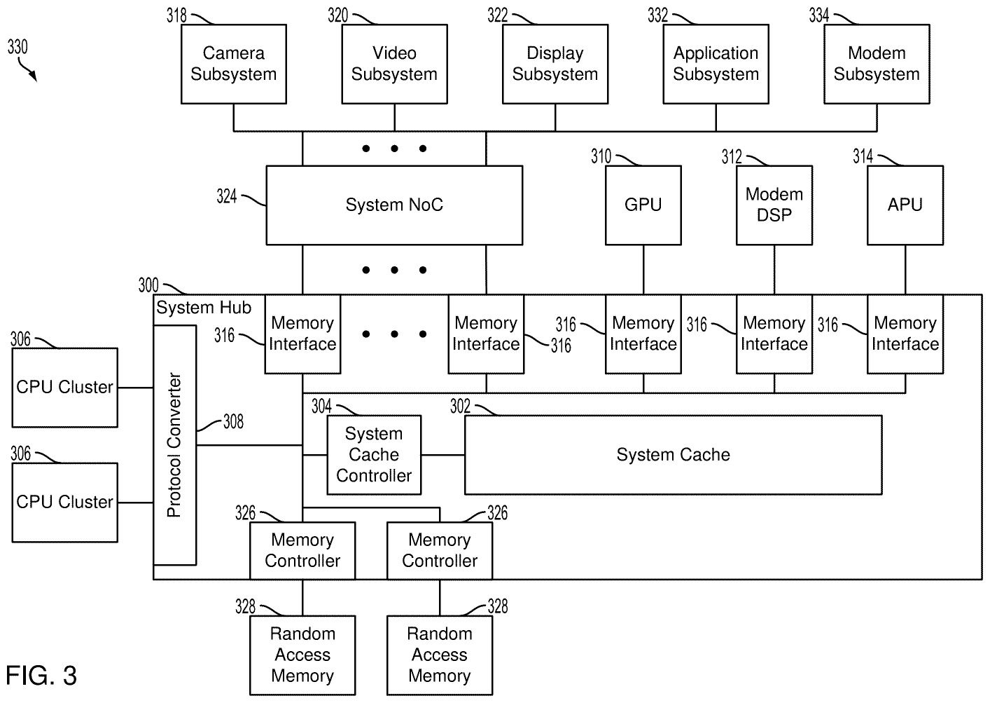

FIG. 3 illustrates a wireless communication device 100 with multiple subsystem components suitable for implementing an embodiment. With reference to FIGS. 1-3, an SoC 330 may include a variety of components as described above. Some such components and additional components may be subsystems of the wireless communication device 100. The SoC 330 may include various communication components configured to communicatively connect the components of the SoC 330 that may transmit, receive, and share data. The communication components may include a system hub 300, a protocol converter 308, and a system network on chip (NoC) 324. The communication components may facilitate communication between subsystem components, such as processors in CPU clusters 306 and various subsystems, such as camera, video, display, application, and modem subsystems 318, 320, 322, 332, 334 and may also include other specialized processors, such as a graphics processor unit (GPU) 310, a modem digital signal processor (DSP) 312, an application processor unit (APU) 314, and other hardware accelerators. The communication components may facilitate communication between the subsystems 318, 320, 322, 332, 334 and the processors 306, 310, 312, 314 with other components such as memory devices, including a system cache 302, a random access memory (RAM) 328, and various memories included in the CPU clusters 306, such as caches of the processors of the CPU cluster 306.

Various memory control devices, such as a system cache controller 304, a memory interface 316, and a memory controller 326, may be configured to control access to the various memories (e.g., RAM 328) by the subsystems 318, 320, 322, 332, 334 and the processors 306, 310, 312, 314 and implement operations for the various memories, which may be requested by the subsystems 318, 320, 322, 332, 334 and the processors 306, 310, 312, 314.

The descriptions herein of the SoC 330 and its various components illustrated in FIG. 3 are only meant to be examples and in no way limiting. Several of the components of the illustrated example SoC 330 may be variably configured, combined, and separated. Several of the components may be included in greater or fewer numbers, and may be located and connected differently within the SoC 330 or separate from the SoC 330. Similarly, numerous other components, such as other memories, processors, subsystems, interfaces, and controllers, may be included in the SoC 330 and in communication with the system cache controller 304 in order to access the system cache 302.

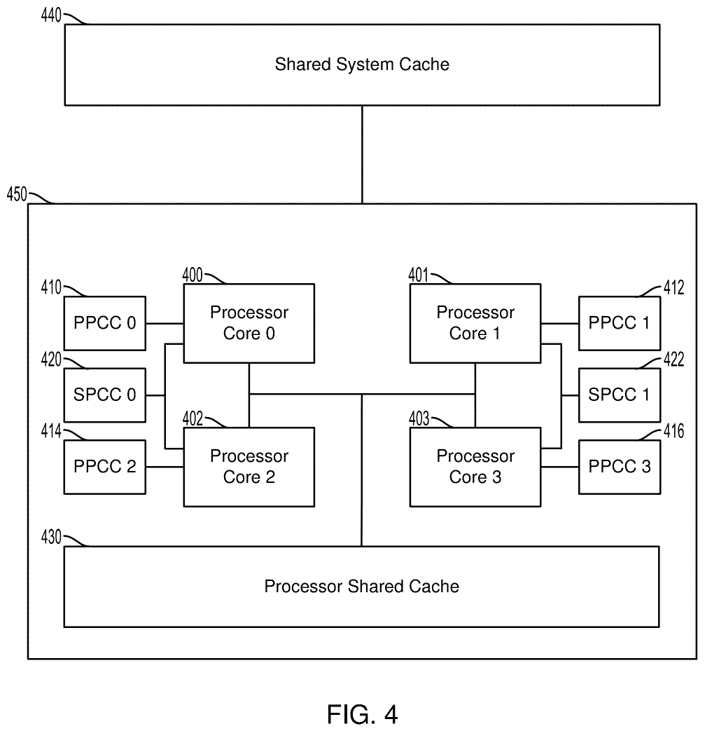

FIG. 4 illustrates components of a wireless communication device 100 suitable for implementing an embodiment. With reference to FIGS. 1-4, a processor 450 (e.g., general purpose processor 106, baseband modem processor 116, data processor 206, 220, processors in CPU clusters 306, GPU 310, DSP 312, and APU 314 in FIGS. 1-3) may include multiple processor types, including, for example, a CPU and various hardware accelerators, such as a GPU, a DSP, an APU, subsystem processor, etc. The processor 450 may also include a custom hardware accelerator, which may include custom processing hardware and/or general purpose hardware configured to implement a specialized set of functions. The processors 450 may include any number of processor cores 400, 401, 402, 403. A processor 450 having multiple processor cores 400, 401, 402, 403 may be referred to as a multicore processor.

The processor 450 may have a plurality of homogeneous or heterogeneous processor cores 400, 401, 402, 403. A homogeneous processor may include a plurality of homogeneous processor cores. The processor cores 400, 401, 402, 403 may be homogeneous in that, the processor cores 400, 401, 402, 403 of the processor 450 may be configured for the same purpose and have the same or similar performance characteristics. For example, the processor 450 may be a general purpose processor, and the processor cores 400, 401, 402, 403 may be homogeneous general purpose processor cores. The processor 450 may be a GPU or a DSP, and the processor cores 400, 401, 402, 403 may be homogeneous graphics processor cores or digital signal processor cores, respectively. The processor 450 may be a custom hardware accelerator with homogeneous processor cores 400, 401, 402, 403.

A heterogeneous processor may include a plurality of heterogeneous processor cores. The processor cores 400, 401, 402, 403 may be heterogeneous in that the processor cores 400, 401, 402, 403 of the processor 450 may be configured for different purposes and/or have different performance characteristics. The heterogeneity of such heterogeneous processor cores may include different instruction set architecture, pipelines, operating frequencies, etc. An example of such heterogeneous processor cores may include what are known as “big.LITTLE” architectures in which slower, low-power processor cores may be coupled with more powerful and power-hungry processor cores. In similar embodiments, an SoC (for example, SoC 330 of FIG. 3) may include any number of homogeneous or heterogeneous processors 450. In various embodiments, not all off the processor cores 400, 401, 402, 403 need to be heterogeneous processor cores, as a heterogeneous processor may include any combination of processor cores 400, 401, 402, 403 including at least one heterogeneous processor core.

Each of the processor cores 400, 401, 402, 403 of a processor 450 may be designated a private processor core cache (PPCC) memory 410, 412, 414, 416 that may be dedicated for read and/or write access by a designated processor core 400, 401, 402, 403. The private processor core cache 410, 412, 414, 416 may store data and/or instructions, and make the stored data and/or instructions available to the processor cores 400, 401, 402, 403, to which the private processor core cache 410, 412, 414, 416 is dedicated, for use in execution by the processor cores 400, 401, 402, 403. The private processor core cache 410, 412, 414, 416 may include volatile memory.

Groups of the processor cores 400, 401, 402, 403 of a processor 450 may be designated a shared processor core cache (SPCC) memory 420, 422 that may be dedicated for read and/or write access by a designated group of processor core 400, 401, 402, 403. The shared processor core cache 420, 422 may store data and/or instructions, and make the stored data and/or instructions available to the group processor cores 400, 401, 402, 403 to which the shared processor core cache 420, 422 is dedicated, for use in execution by the processor cores 400, 401, 402, 403 in the designated group. The shared processor core cache 420, 422 may include volatile memory.

The processor 450 may include a shared processor cache memory 430 that may be dedicated for read and/or write access by the processor cores 400, 401, 402, 403 of the processor 450. The shared processor cache 430 may store data and/or instructions, and make the stored data and/or instructions available to the processor cores 400, 401, 402, 403, for use in execution by the processor cores 400, 401, 402, 403. The shared processor cache 430 may also function as a buffer for data and/or instructions input to and/or output from the processor 450. The shared cache 430 may include volatile memory.

Multiple processors 450 may access a shared system cache memory 440 (e.g., system cache 302 in FIG. 3) that may be dedicated for read and/or write access by the processor cores 400, 401, 402, 403 of the multiple processors 450. The shared system cache 440 may store data and/or instructions, and make the stored data and/or instructions available to the processor cores 400, 401, 402, 403, for use in execution by the processor cores 400, 401, 402, 403. The shared system cache 440 may also function as a buffer for data and/or instructions input to and/or output from the multiple processors 450. The shared system cache 440 may include volatile memory.

In the example illustrated in FIG. 4, the processor 450 includes four processor cores 400, 401, 402, 403 (i.e., processor core 0, processor core 1, processor core 2, and processor core 3). In the example, each processor core 400, 401, 402, 403 is designated a respective private processor core cache 410, 412, 414, 416 (i.e., processor core 0 and private processor core cache 0, processor core 1 and private processor core cache 1, processor core 2 and private processor core cache 2, and processor core 3 and private processor core cache 3). The processor cores 400, 401, 402, 403 may be grouped, and each group may be designated a shared processor core cache 420, 422 (i.e., a group of processor core 0 and processor core 2 and shared processor core cache 0, and a group of processor core 1 and processor core 3 and shared processor core cache 1). For ease of explanation, the examples herein may refer to the four processor cores 400, 401, 402, 403, the four private processor core caches 410, 412, 414, 416, two groups of processor cores 400, 401, 402, 403, and the shared processor core cache 420, 422 illustrated in FIG. 4. However, the four processor cores 400, 401, 402, 403, the four private processor core caches 410, 412, 414, 416, two groups of processor cores 400, 401, 402, 403, and the shared processor core cache 420, 422 illustrated in FIG. 4 and described herein are merely provided as an example and in no way are meant to limit the various embodiments to a four-core processor system with four designated private processor core caches and two designated shared processor core caches 420, 422. The wireless communication device 100, the SoC 330, or the processor 450 may individually or in combination include fewer or more than the four processor cores 400, 401, 402, 403 and private processor core caches 410, 412, 414, 416, and two shared processor core caches 420, 422 illustrated and described herein.

For ease of reference, the terms “hardware accelerator,” “custom hardware accelerator,” “multicore processor,” “processor,” and “processor core” may be used interchangeably herein. The descriptions herein of the illustrated computing device and its various components are only meant to be exemplary and in no way limiting. Several of the components of the illustrated example computing device may be variably configured, combined, and separated. Several of the components may be included in greater or fewer numbers, and may be located and connected differently within the SoC or separate from the SoC.

Various embodiments are described with reference to FIGS. 1-6. The following references to combinations of hardware components are in no way limiting to the number or types of processors, hardware accelerators, controllers, and/or memories that may be included as hardware components for implementing the various embodiments described herein. Various embodiments may be implemented using any combination of components.

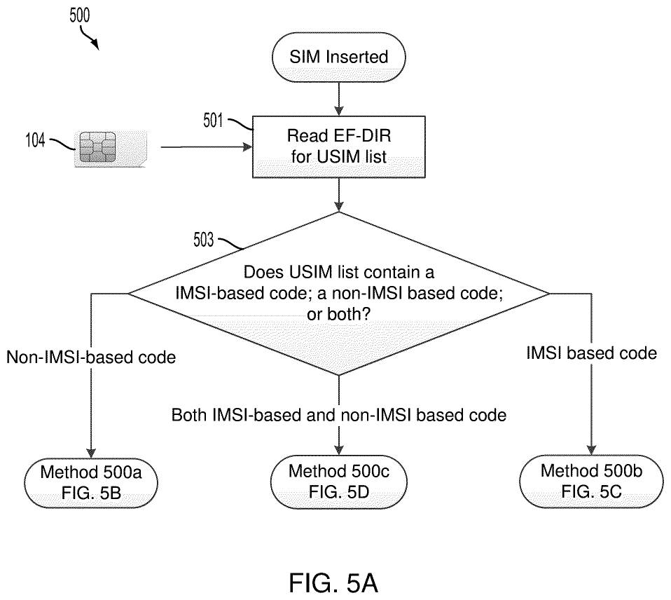

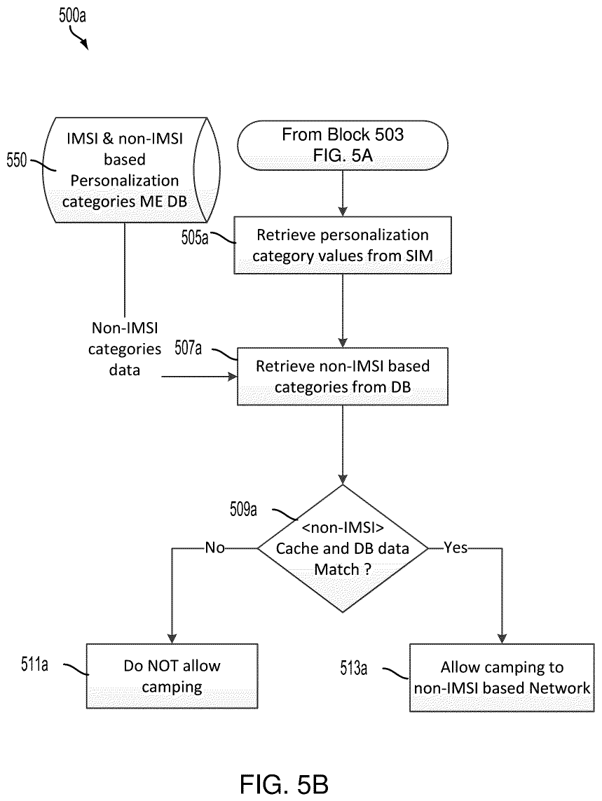

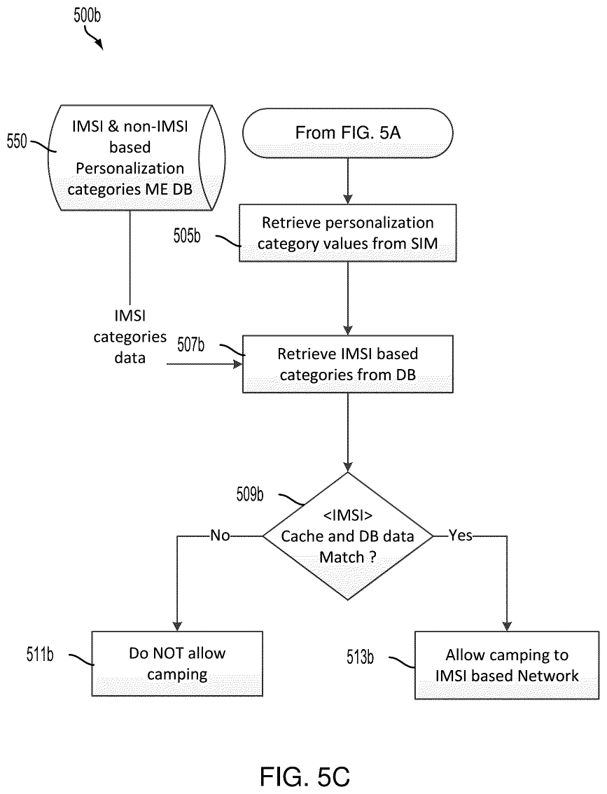

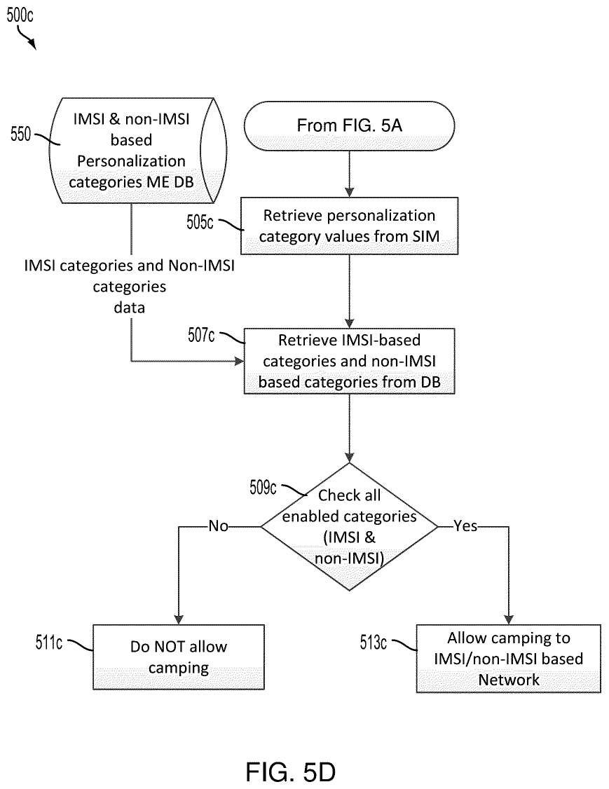

FIGS. 5A-5D illustrates portions of an overall method 500 for dynamically personalizing a wireless communication device according to an embodiment. With reference to FIGS. 1-5D, the method 500 may be implemented in a computing device, in software executing in a processor (e.g., processors 106, 116, 206, 220, 306, 310, 312, 314, 400, 401, 402, 403, and 450, and subsystems 318, 320, 322, 332, and 334), in general purpose hardware, in dedicated hardware (e.g., subsystems 318, 320, 322, 332, and 334), or in a combination of a software-configured processor and dedicated hardware, such as a processor executing software within a wireless communication device personalization system that includes other individual components (e.g., memory 114, 302, 410, 412, 414, 416, 420, 422, 430, 440), and various memory/cache controllers (e.g., controller 304, 326 illustrated). In order to encompass the alternative configurations enabled in various embodiments, the hardware implementing the method 500 is referred to herein as a “processing device.” In various embodiments, the method 500 may be implemented as part of a startup routine of a wireless communication device and/or in response to receiving an unlock request on the wireless communication device to unlock the wireless communication device from a mobile network to which the wireless communication device has a subscription.

Referring to FIG. 5A, in block 501, a SIM card 104 may be inserted into a wireless communication device and the processing device may read the elementary file directory (EF-DIR) to retrieve a USIM list stored thereon. The USIM list may contain a number of parameter values that indicates the mobile network to which the SIM card 104 may allow the wireless communication device to attach to and communicate over. However, to do so, the SIM card 104 identity must be authenticated and the personalization category data stored thereon retrieved and compared against the personalization category data values configured by the original equipment manufacturer (OEM)/mobile network operator that subsidized the wireless communication device. In this manner, the OEM or mobile network operator that subsidized the wireless communication device may “lock” the device to only operate on mobile networks of their choosing by storing the values for the intended personalization categories. These personalization categories may be IMSI-based, non-IMSI-based or both.

In determination block 503, the processing device may analyze the USIM list to determine the personalization category or categories to apply. For example, the USIM list may contain a plurality of USIM application identifier (AID) 3G App Codes. A retrieved USIM AID 3G App code that is a hexadecimal code other than 100B may indicate an application of IMSI based SUPI personalization categories, while a retrieved USIM AID 3G code that is a hexadecimal code 100B may indicate an application of non-IMSI based SUPI personalization categories. Thus, if the USIM list stored in the EF-DIR file includes any USIM AID 3G App Codes that include the hexadecimal code “100B,” the processing device may apply non-IMSI based SUPI personalization categories as the inserted SIM card is associated with and intended to access/attach to (i.e., private 5G networks). However, if the USIM list stored in the EF-DIR file includes any USIM AID 3G App Codes that include the hexadecimal code that is anything other than “100B” (i.e., not “100B”), the processing device may apply IMSI based SUPI personalization categories as the inserted SIM card is associated with and intended to camp to a cellular radio access technology (RAT) networks (i.e., 2G/3G/4G/5G networks).

In some embodiments, the USIM list stored in the EF-DIR file may include USIM AID 3G App Codes that include the hexadecimal code “100B”, as well as USIM AID 3G App Codes that include “not 100B”. In such embodiments, the processing device may apply both IMSI based SUPI and non-IMSI-based personalization categories as the SIM card is intended to operate on cellular radio access technology (RAT) networks (i.e., 2G/3G/4G/5G networks) and a private 5G network. Therefore, in response to determining that a USIM AID 3G code included in the USIM list is “100B,” the processing device may perform operations in the method 500a illustrated in FIG. 5B. In response to determining that a USIM AID 3G code included in the USIM list is “not 100B”, the processing device may perform operations in the method 500b illustrated in FIG. 5C. In response to determining that the USIM list include USIM AID 3G App Codes that include both “100B” and “not 100B”, processing device may perform operations in the method 500c illustrated in FIG. 5D.

As shown in FIG. 5A, if the processing device determines that the USIM list includes a USIM AID 3G code that is a hexadecimal code “100B” then non-IMSI based SUPI personalization categories may be applied as the inserted SIM card is associated with and intended to access/attach to (i.e., private 5G networks). The processing device may perform the operations in the method 500a illustrated in FIG. 5B.

Referring to FIG. 5B, in block 505a, the processing device may retrieve the non-IMSI-based SUPI personalization category data and information stored in the inserted SIM.

In block 507a, the processing device may retrieve the non-IMSI based personalization category data from a mobile equipment (ME) database 550 stored in a memory contained in the wireless communication device. The ME database 550 of personalization category data may be configured on the wireless communication device by the OEM of the wireless communication device and/or by the mobile network operator that is subsidizing the wireless communication device. For example, as new versions of the 5G protocol standard are released, additional personalization categories may be provided. Thus, additional personalization categories and values may be added to a wireless communication device's ME database 550 that impact the personalization security of the wireless communication device. Examples of non-IMSI based SUPI personalization categories may include an elementary file SUPI network access identifier (EF_{SUPI_NAI}), no active carrier subscription (NSI), a global cable identifier (GCI), or a global line identifier (GLI).

In determination block 509a, the non-IMSI-based SUPI personalization category data that is retrieved from the wireless communication device ME database 550 may be compared against the non-IMSI-based SUPI personalization category data retrieved from the SIM card. In response to the non-IMSI-based SUPI personalization category data retrieved from the SIM card matching the non-IMSI-based SUPI personalization category data that is retrieved from the wireless communication device ME database 550 (i.e., determination block 509a=Yes), the processing device may allow the wireless communication device to camp on a non-IMSI-based mobile network for cellular communication service in block 513a. If the wireless communication device is allowed to camp on the cellular mobile network, the processing device continues to camp on the cellular network until the wireless communication device attaches to the cellular mobile network and provides cellular communication. Once the wireless communication device attaches to the cellular mobile network, the processing device may stop the search for network process until a new SIM is inserted in the wireless communication device or the wireless communication device moves out of range of the cellular communication network.

In response to the non-IMSI-based SUPI personalization category data retrieved from the SIM card not matching the non-IMSI-based SUPI personalization category data that is retrieved from the wireless communication device ME database (i.e., determination block 509a=No), the processing device may prevent the wireless communication device from camping on the non-IMSI-based mobile network for cellular communication service block 511a. If the wireless communication device is not allowed to camp on the cellular mobile network, the processing device may stop the search for network process until a new SIM is inserted in the wireless communication device.

As shown in FIG. 5A, if the processing device determines that the USIM list includes a USIM AID 3G code that is a hexadecimal code “not 100B” then IMSI based SUPI personalization categories may be applied as the inserted SIM card is associated with and intended to camp on a cellular radio access technology (RAT) network (i.e., a 2G/3G/4G/5G network). The processing device may perform the operations in the method 500b illustrated in FIG. 5C.

Referring to FIG. 5C, in block 505b, the processing device may retrieve the IMSI-based SUPI personalization category data and information stored in the inserted SIM.

In block 507b, the processing device may retrieve the IMSI based personalization category data from a ME database 550 stored in a memory contained in the wireless communication device. The ME database 550 of personalization category data may be configured on the wireless communication device by the OEM of the wireless communication device and/or by the mobile network operator that is subsidizing the wireless communication device. For example, for an IMSI-based SUPI, personalization categories may include, but are not limited to mobile country code (MCC), a mobile network code (MNC), a group identifier level 1 (GID1), of a group identifier level 2 (GID2).

In determination block 509b, the IMSI-based SUPI personalization category data that is retrieved from the wireless communication device ME database 550 may be compared against the IMSI-based SUPI personalization category data retrieved from the SIM card. In response to the IMSI-based SUPI personalization category data retrieved from the SIM card matching the IMSI-based SUPI personalization category data that is retrieved from the wireless communication device ME database 550 (i.e., determination block 509b=Yes), the processing device may allow the wireless communication device to camp on an IMSI-based mobile network for wireless communication service such as cellular RAT networks (i.e., 2G/3G/4G/5G networks) in block 513b. If the wireless communication device is allowed to camp on the cellular RAT networks (i.e., 2G/3G/4G/5G networks), the processing device continues to camp on the cellular RAT networks (i.e., 2G/3G/4G/5G networks) until the wireless communication device attaches to the cellular RAT networks (i.e., 2G/3G/4G/5G networks) and provides communication services. Once the wireless communication device attaches to the cellular RAT networks (i.e., 2G/3G/4G/5G networks), the processing device may stop the search for network process until a new SIM is inserted in the wireless communication device or the wireless communication device moves out of range of the cellular RAT networks (i.e., 2G/3G/4G/5G networks).

In response to the IMSI-based SUPI personalization category data retrieved from the SIM card not matching the IMSI-based SUPI personalization category data that is retrieved from the wireless communication device ME database 550 does (i.e., determination block 509b=No), the processing device may prevent the wireless communication device from camping on the IMSI-based mobile network for communication service in block 511b. If the wireless communication device is not allowed to camp on the mobile network, the processing device may stop the search for network process until a new SIM is inserted in the wireless communication device.

As shown in FIG. 5A, if the processing device determines that the USIM list includes a USIM AID 3G code that is a hexadecimal code “not 100B” and a USIM AID 3G code that is a hexadecimal code “100B”, then both IMSI based SUPI personalization categories and non-IMSI based SUPI personalization categories may be applied as the inserted SIM card is associated with and intended to access/attach to both cellular RATs (e.g., 2G/3G/4G/5G cellular networks) as well as private 5G networks. In that case, the processing device may perform the operations in the method 500c illustrated in FIG. 5D.

Referring to FIG. 5D, in block 505c, the processing device may retrieve both the IMSI-based SUPI personalization category data and information as well as non-IMSI-based SUPI personalization category data and information stored in the inserted SIM.

In block 507c, the processing device may retrieve both the IMSI-based SUPI personalization category data and information as well as non-IMSI-based SUPI personalization category data and information from a ME database 550 stored in a memory contained in the wireless communication device. The ME database 550 of IMSI-based SUPI and non-IMSI-based SUPI personalization category data may be configured on the wireless communication device by the OEM of the wireless communication device and/or by the mobile network operator that is subsidizing the wireless communication device. The IMSI-based SUPI personalization categories and non-IMSI-based SUPI personalization categories may be the personalization categories identified above with reference to FIGS. 5B and 5C.

In determination block 509c, the IMSI-based SUPI personalization category data and non-IMSI-based personalization category data that is retrieved from the wireless communication device ME database 550 may be compared against the IMSI-based SUPI personalization category data and non-IMSI-based personalization category data retrieved from the SIM card.

In response to the IMSI-based SUPI personalization category data retrieved from the SIM card matching the IMSI-based SUPI personalization category data that is retrieved from the wireless communication device ME database 550 or the non-IMSI-based SUPI personalization category data retrieved from the SIM card matching the non-IMSI-based SUPI personalization category data that is retrieved from the wireless communication device ME database 550 (i.e., determination block 509c=Yes), the processing device may allow the wireless communication device to camp on either a IMSI-based mobile network for wireless communication service (e.g., private 5G network) or non-IMSI-based cellular communication network (i.e., 2G/3G/4G cellular network) in block 513c. If the wireless communication device is allowed to camp on the private 5G network or cellular network, the processing device continues to camp on the private 5G network or cellular network until the wireless communication device attaches to either network and provides communication services. Once the wireless communication device attaches to either network, the processing device may stop the search for network process until a new SIM is inserted in the wireless communication device or the wireless communication device moves out of range of the attached communication network.

In response to either the IMSI-based SUPI personalization category data that is retrieved from the wireless communication device ME database 550 not matching the IMSI-based SUPI personalization category data retrieved from the SIM card or the non-IMSI-based SUPI personalization category data that is retrieved from the wireless communication device ME database 550 not matching the non-IMSI-based SUPI personalization category data retrieved from the SIM card (i.e., determination block 509c=No), the processing device may prevent the wireless communication device from camping on either the IMSI-based mobile network or non-IMSI-based mobile network for communication service in block 511c. If the wireless communication device is not allowed to camp on either mobile network, the processing device may stop the search for network process until a new SIM is inserted in the wireless communication device.

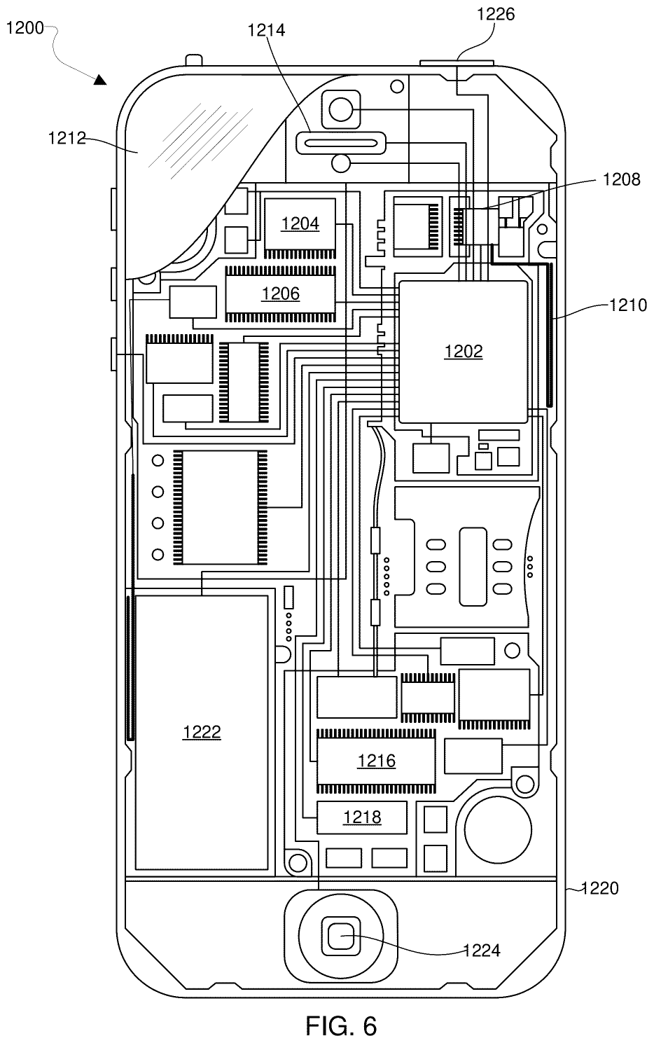

The various embodiments (including, but not limited to, embodiments described above with reference to FIGS. 1-5D) may be implemented in a wide variety of computing systems including wireless communication devices, an example of which suitable for use with the various embodiments is illustrated in FIG. 6. The wireless communication device 1200 may include a processing device 1202 coupled to a touchscreen controller 1204 and an internal memory 1206. The processing device 1202 may be one or more multicore integrated circuits designated for general or specific processing tasks. The internal memory 1206 may be volatile or non-volatile memory, and may also be secure and/or encrypted memory, or unsecure and/or unencrypted memory, or any combination thereof. Examples of memory types that can be leveraged include but are not limited to DDR, LPDDR, GDDR, WIDEIO, RAM, SRAM, DRAM, P-RAM, R-RAM, M-RAM, STT-RAM, and embedded DRAM. The touchscreen controller 1204 and the processing device 1202 may also be coupled to a touchscreen panel 1212, such as a resistive-sensing touchscreen, capacitive-sensing touchscreen, infrared sensing touchscreen, etc. Additionally, the display of the computing device 1200 need not have touch screen capability.

The wireless communication device 1200 may have one or more radio signal transceivers 1208 (e.g., Peanut, Bluetooth, ZigBee, Wi-Fi, RF radio) and antennae 1210, for sending and receiving communications, coupled to each other and/or to the processing device 1202. The transceivers 1208 and antennae 1210 may be used with the above-mentioned circuitry to implement the various wireless transmission protocol stacks and interfaces. The wireless communication device 1200 may include a cellular network wireless modem chip 1216 that enables communication via a cellular network and is coupled to the processing device.

The wireless communication device 1200 may include a peripheral device connection interface 1218 coupled to the processing device 1202. The peripheral device connection interface 1218 may be singularly configured to accept one type of connection, or may be configured to accept various types of physical and communication connections, common or proprietary, such as Universal Serial Bus (USB), FireWire, Thunderbolt, or PCIe. The peripheral device connection interface 1218 may also be coupled to a similarly configured peripheral device connection port (not shown).

The wireless communication device 1200 may also include speakers 1214 for providing audio outputs. The wireless communication device 1200 may also include a housing 1220, constructed of a plastic, metal, or a combination of materials, for containing all or some of the components described herein. The wireless communication device 1200 may include a power source 1222 coupled to the processing device 1202, such as a disposable or rechargeable battery. The rechargeable battery may also be coupled to the peripheral device connection port to receive a charging current from a source external to the wireless communication device 1200. The wireless communication device 1200 may also include a physical button 1224 for receiving user inputs. The wireless communication device 1200 may also include a power button 1226 for turning the wireless communication device 1200 on and off.

A number of different cellular and mobile communication services and standards are available or contemplated in the future, all of which may implement and benefit from Various embodiments. Such services and standards include, e.g., third generation partnership project (3GPP), long term evolution (LTE) systems, third generation wireless mobile communication technology (3G), fourth generation wireless mobile communication technology (4G), fifth generation wireless mobile communication technology (5G), global system for mobile communications (GSM), universal mobile telecommunications system (UMTS), 3GSM, general packet radio service (GPRS), code division multiple access (CDMA) systems (e.g., cdmaOne, CDMA1020TM), enhanced data rates for GSM evolution (EDGE), advanced mobile phone system (AMPS), digital AMPS (IS-136/TDMA), evolution-data optimized (EV-DO), digital enhanced cordless telecommunications (DECT), Worldwide Interoperability for Microwave Access (WiMAX), wireless local area network (WLAN), Wi-Fi Protected Access I & II (WPA, WPA2), and integrated digital enhanced network (iDEN). Each of these technologies involves, for example, the transmission and reception of voice, data, signaling, and/or content messages. It should be understood that any references to terminology and/or technical details related to an individual telecommunication standard or technology are for illustrative purposes only, and are not intended to limit the scope of the claims to a particular communication system or technology unless specifically recited in the claim language.

Implementation examples are described in the following paragraphs. While some of the following implementation examples are described in terms of example methods, further example implementations may include: the example methods discussed in the following paragraphs implemented by a wireless communication device that includes a processing device configured with processor-executable instructions to perform operations of the methods of the following implementation examples; the example methods discussed in the following paragraphs implemented by a wireless communication device including means for performing functions of the methods of the following implementation examples; and the example methods discussed in the following paragraphs may be implemented as a non-transitory processor-readable storage medium having stored thereon processor-executable instructions configured to cause a wireless communication device processor to perform the operations of the methods of the following implementation examples.

Example 1. A method for dynamically personalizing a wireless communication device, including: retrieving USIM AID 3G App codes contained in an EF-DIR list stored on a SIM card that is inserted in the wireless communication device; in response to the retrieved USIM AID 3G code indicating an application of IMSI based SUPI personalization categories: retrieving IMSI based SUPI personalization category data from a IMSI based personalization category ME database; and allowing the wireless communication device to camp to an IMSI based network in response to the retrieved IMSI based SUPI personalization category data matching personalization category data stored on the SIM card; and in response to the retrieved USIM AID 3G code indicating an application of non-IMSI based SUPI personalization categories: retrieving non-IMSI based SUPI personalization category data from a non-IMSI based personalization category ME database; and allowing the wireless communication device to camp to a non-IMSI based network in response to the retrieved non-IMSI based SUPI personalization category data matching personalization category data stored on the SIM card.

Example 2. The method of example 1 in which a retrieved USIM AID 3G App code that is a hexadecimal code other than 100B indicates an application of IMSI based SUPI personalization categories.

Example 3. The method of any of examples 1-2 in which a retrieved USIM AID 3G code that is a hexadecimal code 100B indicates an application of non-IMSI based SUPI personalization categories.

Example 4. The method of any of examples 1-3 in which a single IMSI and non-IMSI based personalization category ME database includes the IMSI based personalization category ME database and the non-IMSI based personalization category ME database.

Example 5. The method of any of examples 1-4 in which the IMSI based personalization category ME database and non-IMSI based personalization category ME database are each configured by an OEM or mobile network operator.

Example 6. The method of any of examples 1-5 in which the IMSI based SUPI personalization categories include an MCC, an MNC, a GID1, or a GID2.

Example 7. The method of any of examples 1-6 in which the non-IMSI based SUPI personalization categories include an EF_{SUPI_NAI}, an NSI, a GCI, or a GLI.

Example 8. The method of any of examples 1-7, further including: not allowing the wireless communication device to camp to an IMSI based network in response to the retrieved IMSI based SUPI personalization category data not matching personalization category data stored on the SIM card; and not allowing the wireless communication device to camp to a non-IMSI based network in response to the retrieved non-IMSI based SUPI personalization category data not matching personalization category data stored on the SIM card.

Computer program code or “program code” for execution on a programmable processor for carrying out operations of the various embodiments may be written in a high level programming language such as C, C++, C#, Smalltalk, Java, JavaScript, Visual Basic, a Structured Query Language (e.g., Transact-SQL), Perl, or in various other programming languages. Program code or programs stored on a computer readable storage medium as used in this application may refer to machine language code (such as object code) whose format is understandable by a processor.

The foregoing method descriptions and the process flow diagrams are provided merely as illustrative examples and are not intended to require or imply that the operations of the various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the various embodiments may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the embodiments disclosed herein may be implemented or performed with a general purpose processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable medium or a non-transitory processor-readable medium. The operations of a method or algorithm disclosed herein may be embodied in a processor-executable software module that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments and implementations without departing from the scope of the claims. Thus, the present disclosure is not intended to be limited to the embodiments and implementations described herein, but is to be accorded the widest scope consistent with the following claims and the principles and novel features disclosed herein.

What is claimed is:

1. A method for dynamically personalizing a wireless communication device, comprising:
retrieving universal Subscriber Identity Module (USIM) application identifier (AID) 3G App codes contained in an elementary file directory (EF-DIR) list stored on a subscriber identification module (SIM) card that is inserted in the wireless communication device;
in response to the retrieved USIM AID 3G code indicating an application of international mobile subscriber identification (IMSI) based Subscription Permanent Identifier (SUPI) personalization categories:
retrieving IMSI based SUPI personalization category data from a IMSI based personalization category mobile equipment (ME) database; and
allowing the wireless communication device to camp to an IMSI based network in response to the retrieved IMSI based SUPI personalization category data matching personalization category data stored on the SIM card; and
in response to the retrieved USIM AID 3G code indicating an application of non-IMSI based SUPI personalization categories:
retrieving non-IMSI based SUPI personalization category data from a non-IMSI based personalization category ME database; and
allowing the wireless communication device to camp to a non-IMSI based network in response to the retrieved non-IMSI based SUPI personalization category data matching personalization category data stored on the SIM card.

2. The method of claim 1, wherein a retrieved USIM AID 3G App code that is a hexadecimal code other than 100B indicates an application of IMSI based SUPI personalization categories.

3. The method of claim 1, wherein a retrieved USIM AID 3G code that is a hexadecimal code 100B indicates an application of non-IMSI based SUPI personalization categories.

4. The method of claim 1, wherein a single IMSI and non-IMSI based personalization category ME database comprises the IMSI based personalization category ME database and the non-IMSI based personalization category ME database.

5. The method of claim 4, wherein the IMSI based personalization category ME database and non-IMSI based personalization category ME database are each configured by an original equipment manufacturer (OEM) or mobile network operator.

6. The method of claim 1, wherein the IMSI based SUPI personalization categories comprise a mobile country code (MCC), a mobile network code (MNC), a group identifier level 1 (GID1), or a group identifier level 2 (GID2).

7. The method of claim 1, wherein the non-IMSI based SUPI personalization categories comprise an elementary file SUPI network access identifier (EF_{SUPI_NAI}), Network Subscription Identifier (NSI), a global cable identifier (GCI), or a global line identifier (GLI).

8. The method of claim 1, further comprising:
not allowing the wireless communication device to camp to an IMSI based network in response to the retrieved IMSI based SUPI personalization category data not matching personalization category data stored on the SIM card; and
not allowing the wireless communication device to camp to a non-IMSI based network in response to the retrieved non-IMSI based SUPI personalization category data not matching personalization category data stored on the SIM card.

9. A wireless communication device, comprising:
a subscriber identification module (SIM) card receiver; and
a processor coupled to the SIM card receiver, wherein the processor is configured with processor-executable instructions to:
retrieve universal Subscriber Identity Module (USIM) application identifier (AID) 3G App codes contained in an elementary file directory (EF-DIR) list stored on a subscriber identification module (SIM) card that is inserted in the wireless communication device;
in response to the retrieved USIM AID 3G code indicating an application of international mobile subscriber identification (IMSI) based Subscription Permanent Identifier (SUPI) personalization categories:
retrieve IMSI based SUPI personalization category data from a IMSI based personalization category mobile equipment (ME) database; and
allow the wireless communication device to camp to an IMSI based network in response to the retrieved IMSI based SUPI personalization category data matching personalization category data stored on the SIM card; and
in response to the retrieved USIM AID 3G code indicating an application of non-IMSI based SUPI personalization categories:
retrieve non-IMSI based SUPI personalization category data from a non-IMSI based personalization category ME database; and
allow the wireless communication device to camp to a non-IMSI based network in response to the retrieved non-IMSI based SUPI personalization category data matching personalization category data stored on the SIM card.

10. The wireless communication device of claim 9, wherein a retrieved USIM AID 3G App code that is a hexadecimal code other than 100B indicates an application of IMSI based SUPI personalization categories.

11. The wireless communication device of claim 9, wherein a retrieved USIM AID 3G code that is a hexadecimal code 100B indicates an application of non-IMSI based SUPI personalization categories.

12. The wireless communication device of claim 9, wherein a single IMSI and non-IMSI based personalization category ME database comprises the IMSI based personalization category ME database and the non-IMSI based personalization category ME database.

13. The wireless communication device of claim 12, wherein the IMSI based personalization category ME database and non-IMSI based personalization category ME database are each configured by an original equipment manufacturer (OEM) or mobile network operator.

14. The wireless communication device of claim 9, wherein the IMSI based SUPI personalization categories comprise a mobile country code (MCC), a mobile network code (MNC), a group identifier level 1 (GID1), or a group identifier level 2 (GID2).

15. The wireless communication device of claim 9, wherein the non-IMSI based SUPI personalization categories comprise an elementary file SUPI network access identifier (EF_{SUPI_NAI}), Network Subscription Identifier (NSI), a global cable identifier (GCI), or a global line identifier (GLI).

16. The wireless communication device of claim 9, wherein the processor is further configured with processor-executable instructions to:
not allow the wireless communication device to camp to an IMSI based network in response to the retrieved IMSI based SUPI personalization category data not matching personalization category data stored on the SIM card; and
not allow the wireless communication device to camp to a non-IMSI based network in response to the retrieved non-IMSI based SUPI personalization category data not matching personalization category data stored on the SIM card.

17. A wireless communication device, comprising:
means for retrieving universal Subscriber Identity Module (USIM) application identifier (AID) 3G App codes contained in an elementary file directory (EF-DIR) list stored on a subscriber identification module (SIM) card that is inserted in the wireless communication device;
means for retrieving international mobile subscriber identification (IMSI) based Subscription Permanent Identifier (SUPI) personalization category data from a IMSI based personalization category mobile equipment (ME) database in response to the retrieved USIM AID 3G code indicating an application of IMSI based Subscription Permanent Identifier (SUPI) personalization categories; and
means for allowing the wireless communication device to camp to an IMSI based network in response to retrieved IMSI based SUPI personalization category data matching personalization category data stored on the SIM card;
means for retrieving non-IMSI based SUPI personalization category data from a non-IMSI based personalization category ME database in response to the retrieved USIM AID 3G code indicating an application of non-IMSI based SUPI personalization categories; and
means for allowing the wireless communication device to camp to a non-IMSI based network in response to retrieved non-IMSI based SUPI personalization category data matching personalization category data stored on the SIM card.

18. The wireless communication device of claim 17, wherein a retrieved USIM AID 3G App code that is a hexadecimal code other than 100B indicates an application of IMSI based SUPI personalization categories.

19. The wireless communication device of claim 17, wherein a retrieved USIM AID 3G code that is a hexadecimal code 100B indicates an application of non-IMSI based SUPI personalization categories.

20. The wireless communication device of claim 17, wherein a single IMSI and non-IMSI based personalization category ME database comprises the IMSI based personalization category ME database and the non-IMSI based personalization category ME database.

21. The wireless communication device of claim 20, wherein the IMSI based personalization category ME database and non-IMSI based personalization category ME database are each configured by an original equipment manufacturer (OEM) or mobile network operator.

22. The wireless communication device of claim 17, wherein the IMSI based SUPI personalization categories comprise a mobile country code (MCC), a mobile network code (MNC), a group identifier level 1 (GID1), or a group identifier level 2 (GID2).

23. The wireless communication device of claim 17, wherein the non-IMSI based SUPI personalization categories comprise an elementary file SUPI network access identifier (EF_{SUPI_NAI}), Network Subscription Identifier (NSI), a global cable identifier (GCI), or a global line identifier (GLI).

24. The wireless communication device of claim 17, further comprising:
means for not allowing the wireless communication device to camp to an IMSI based network in response to the retrieved IMSI based SUPI personalization category data not matching personalization category data stored on the SIM card; and
means for not allowing the wireless communication device to camp to a non-IMSI based network in response to the retrieved non-IMSI based SUPI personalization category data not matching personalization category data stored on the SIM card.

25. A non-transitory computer readable storage medium having stored thereon processor-executable software instructions configured to cause a processor of a wireless communication device to perform operations comprising:
retrieving universal Subscriber Identity Module (USIM) application identifier (AID) 3G App codes contained in an elementary file directory (EF-DIR) list stored on a subscriber identification module (SIM) card that is inserted in the wireless communication device;
in response to determining that the retrieved USIM AID 3G code indicating an application of international mobile subscriber identification (IMSI) based Subscription Permanent Identifier (SUPI) personalization categories:
retrieving IMSI based SUPI personalization category data from a IMSI based personalization category mobile equipment (ME) database;
determining whether personalization category data stored on the SIM card matches the retrieved IMSI based SUPI personalization category data; and
allowing the wireless communication device to camp to an IMSI based network in response to determining that personalization category data stored on the SIM card matches the retrieved IMSI based SUPI personalization category data; and
in response to the retrieved USIM AID 3G code indicating an application of non-IMSI based SUPI personalization categories:
retrieving non-IMSI based SUPI personalization category data from a non-IMSI based personalization category ME database; and
allowing the wireless communication device to camp to a non-IMSI based network in response to the retrieved non-IMSI based SUPI personalization category data matching personalization category data stored on the SIM card.

26. The non-transitory computer readable storage medium of claim 25, wherein:
a retrieved USIM AID 3G App code that is a hexadecimal code other than 100B indicates an application of IMSI based SUPI personalization categories; and
a retrieved USIM AID 3G code that is a hexadecimal code 100B indicates an application of non-IMSI based SUPI personalization categories.

27. The non-transitory computer readable storage medium of claim 25, wherein a single IMSI and non-IMSI based personalization category ME database comprises the IMSI based personalization category ME database and the non-IMSI based personalization category ME database.

28. The non-transitory computer readable storage medium of claim 25, wherein the IMSI based personalization category ME database and non-IMSI based personalization category ME database are each configured by an original equipment manufacturer (OEM) or mobile network operator.

29. The non-transitory computer readable storage medium of claim 25, wherein the non-IMSI based SUPI personalization categories comprise an elementary file SUPI network access identifier (EF_{SUPI_NAI}), Network Subscription Identifier (NSI), a global cable identifier (GCI), or a global line identifier (GLI).

30. The non-transitory computer readable storage medium of claim 25, wherein the processor is further configured with processor-executable instructions to perform operations further comprising:
not allowing the wireless communication device to camp to an IMSI based network in response to the retrieved IMSI based SUPI personalization category data not matching personalization category data stored on the SIM card; and
not allowing the wireless communication device to camp to a non-IMSI based network in response to the retrieved non-IMSI based SUPI personalization category data not matching personalization category data stored on the SIM card.
